(19) United States
(12) Patent Application Publication
(10) Pub. No.: US 2025/0291368 A1
(43) Pub. Date: Sep. 18, 2025

(54) Systems, Methods and Apparatuses for Appliance Knob Timers

(71) Applicants: James Clarke, Washington, DC (US); Forward Entertainment & Technology LLC, Washington, DC (US)

(72) Inventors: James Lowell Ramsey Clarke, Washington, DC (US); Timothy Logan Melham, Accokeek, MD (US); Chiedo Raymond Ohanyerenwa, Washington, DC (US); John Ramsey Clarke, Lawrence Township, NJ (US); Jeffrey Frederick, Accokeek, MD (US)

(73) Assignee: Forward Entertainment & Technology LLC, Washington, DC (US)

(21) Appl. No.: 19/083,368

(22) Filed: Mar. 18, 2025

Related U.S. Application Data
(60) Provisional application No. 63/566,389, filed on Mar. 18, 2024.

(51) Int. Cl. G05D 3/12; F03G 1/08; F24C 3/12; F24C 7/08; G05G 5/05; H01H 19/14

(52) U.S. Cl. CPC G05D 3/12; F03G 1/08; F24C 3/126; F24C 7/082; G05G 5/05; H01H 19/14; G05G 2505/00

(57) ABSTRACT

An apparatus and system for driving an appliance knob to a predetermined position once a timer reaches zero. Variations of this disclosure include but are not limited to embodiments where the device has clamps which clasp the appliance knob and drive it to zero after a spring is depressed or motor activated, where the device includes a dial which can be turned so the user decides where to block the spring from turning further or deactivate the motor such that the appliance remains on at a different setting, where the device includes a plurality of dials and related blocks so that the spring can be stopped or motor deactivated once the timer reaches a position and then released or reactivated respectively once the timer reaches a new position repeatedly. A preferred embodiment of this disclosure comprises an interchangeable cover for an oven or stove knob with installable and removable features.

### CROSS-REFERENCE TO RELATED APPLICATION

The present application claims priority to U.S. Provisional Patent Application No. 63/566,389, filed Mar. 18, 2024. The entire disclosure of U.S. Provisional Patent Application No. 63/566,389 is incorporated herein by reference.

### TECHNICAL FIELD

The general field of the disclosure herein relates to the design of an apparatus and system for a knob turning device that may be used for appliances. More specifically this apparatus and system involves a device that may be placed over a pre-existing analog appliance knob, such as those on ovens, and stoves, and may allow the user to set the time until the device drives the knob to the off position or a lower user defined position. The apparatus and systems of the disclosure may be driven by various means, including but not limited to a dial based mechanical device involving a motor driven unit, a device driven by pneumatic means to a set endpoint, a device driven by a series of electrical impulses to a plurality of preset points at a respective plurality of preset times, a device that serves as a universal cover for a knob and may be moved from the oven knob to a stove knob on any number of appliances, grasping onto the knob with a clamp operated by the user initially, that drives the knob to close after it is preset only after the timing device reaches zero and the pin stopping the spring loaded dial is therefore removed, or any combination of the aforementioned. This also encompasses autonomous and semi-autonomous variations of this device, in some cases with acoustic sensors, tactile sensors or some other interoperating sensors.

### BACKGROUND

In the field of appliances, timers have long been considered an important safety feature. From kitchen timers and alarms that warn when a user should shut off an oven to automatic irons that turn off when the unit has been left standing idle for an extended period of time, these devices can alert users to avert disaster, or provide a user with the peace of mind that a device will shut off if it is left on inadvertently, thereby reducing the risk of fire and potential loss of life. With regard to kitchen appliances there are many modern ovens and stoves from automatic microwave ovens to smart ovens that are digitally operated to turn an electric oven or gas range off once the timer reaches zero. However due to the expense of buying a new large appliance, sizing considerations such as removing cabinetry, and often the requirement to remove gas from the building or the unit altogether, the solution of buying a new appliance is often neither practical nor affordable for many. That however does not negate the need for or worry associated with such appliances. This worry may be felt by parents who have absent minded teens at home, who forget to turn off an oven, a retiree whose spouse falls asleep while cooking, or families who live in apartments occupied by distracted neighbors who may be likely to leave a device on that could burn down the entire complex without sufficient warning. Devices that may help reduce such worry and prevent disaster from the simple to the complex are as important as they are novel. This disclosure herein relates to a simple yet effective means of updating age old appliances, particularly but not limited to gas stoves and oven ranges. The device herein differentiates itself from the prior art in that it is designed to be interchangeable from one unit to the next, and may be universally sized to adjust to fit a variety of pre-existing knob designs. This device can also be plugged in to an outlet in some embodiments for variation between DC power and AC power. In some such embodiments this device may automatically activate in the kitchen by detecting a certain pattern of beeps from acoustically autonomous interfacing stoves and appliances, designed to send a pattern of beeps in alignment with the timer, in order to activate it. In some such embodiments the device may be both an AC and DC interfacing device (capable of charging DC batteries in some such embodiments, and preserving DC power in some other such embodiments.

### SUMMARY OF THE INVENTION

This disclosure is an apparatus and system for a universal knob timer that may fit in place of an appliance knob, or fit over and be adjusted to clasp a knob and drive it to a user determined point after a set amount of time. Among the objectives of this disclosure is to provide related variations to a design that accomplishes this feat of driving an existing appliance with an analog knob to turn it off through various means including but not limited to a mechanical motor, a spring-loaded pin, a pneumatic actuator, a hydraulic actuator, a magnetic driver, or any combination of the aforementioned.

In some embodiments a sensor may activate the device by sensed energy including but not limited to a pattern of beeps, voice recognition or some other auditory, tactile, or sensed temperature variation.

In some embodiments the device may be an original timer that plugs directly into an outlet and modulates the energy supplied to an appliance, such that it can adjust the temperature to an oven or shut it off entirely if a signal is detected, including but not limited to the presence of smoke, a sufficient change in temperature, the passage of time or an actual detected signal from a user's device, artificial intelligence-controlled device, an algorithm or an attendant technician device.

While it is envisioned that this disclosure will be used for the purposes of making kitchens safer and/or more predictable through efficient means, additional uses, including but not limited to modulating the amount of water supplied from a pre-existing faucet, releasing safety devices or fluids from existing containers, or varying the power to or volume of an existing device, are possible.

While the preferred embodiments of the disclosure are shown in the accompanying drawings, it to be understood that said embodiments are susceptible to modification and alteration while still maintaining the spirit of my invention.

### BRIEF DESCRIPTION OF THE DRAWINGS

FIG. 1 is an image of a knob timer which may be fitted over various sizes of knobs, wherein one or more spring loaded mechanisms may drive said knob to one or more positions, once the knob timer reaches one or more positions, triggering a release of one or more springs.

FIG. 2 is an image of a knob timer which may be fitted over various sizes of knobs, wherein the left and right prongs may be rotated and fitted over said knob and reset to their original position via mechanical gears that are propelled by a motor once the timer one or more setpoints.

FIG. 3 is an image of a knob timer which may be adjoined to and drive an inner knob by mechanism including but not limited to arms with suction cups on the end, which rotate in the direction driven by one or more knob timers.

FIG. 4 is an image of a knob timer device with an environmental sensor, including but not limited to auditory (in some embodiments specifically a microphone, visual (in some embodiments, specifically a photosensor that detects a pattern of light blinks from a device designed to interoperate), temperature, or due to sensed gases, including but not limited to LEL, smoke, or carbon monoxide, causing the knob timer to drive to one or more positions.

FIG. 5 is an image of a knob timer with an AC adapter, for recharging or extended DC preservation in some such embodiments.

FIG. 6 is an image of a knob sensor which is interoperating with an additional sensor designed in some embodiments to detect the presence of smoke, gases or other sensed items that the original knob sensor may not be able to detect, and sending a signal that the original knob sensor can detect, thereby driving the original knob to one or more positions.

FIG. 7 is an image of a knob timer which may be plugged directly into an outlet and can adjust, deactivate or activate an appliance based on a detected sound, scent, auditory signal or digital signal received.

FIG. 8 is an image of a user holding a cell phone and sending a signal to a knob timer to change its position or program it to adjust its parameters accordingly.

FIG. 9 is an image of a device sending a signal to a knob timer, which a knob timer receives, adjusts in response to or communicates back with information regarding its position to, or some combination therein.

FIG. 10 Is an exemplary flowchart showing the typical database hierarchy with data sent to and from a device including but not limited to a system of knob sensors or sensors that interoperate with the knob timer and send one or more signals to the knob timer in order to drive it to one or more positions, and may comprise additional functions including but not limited sensing when one or signals are received including but not limited to audio, visual, tactile, temperate, digital from another device or a user input and sends a signal to the knob timer or records data regarding the timer, including but not limited to its position, battery life, temperature, or another signal sent from the knob timer and stored in the database.

FIG. 11 is a drawing illustrating a variety of knob timers that may be placed over a knob, or an exemplary embodiment of a stub behind a stove or over knob and the mechanisms behind it.

FIG. 12 is a drawing of a pivot mounted knob with controls a timer display and set screws that may be used to drive a stove knob to the off position, with enough space for a “push in” on gas stoves.

FIG. 13 is a drawing representing a pivoting spring-loaded flywheel-based knob timer that can be set with a trigger and reoriented as much as 360 degrees and has space for additional mechanisms to be attached.

FIG. 14 is an image showing the inner workings of a spring-loaded flywheel-based trigger as taken apart, and shown in various positions as extruded.

FIG. 15 is figure showing a knob timer with a safety cover, where a kitchen knob may be driven to close by a spring and latch trigger system.

FIG. 16 is an overview drawing illustrating various views of a kitchen, where a timer knob may be used to shut off a stove or oven for convenience and fire safety.

FIG. 17 is an overview drawing illustrating a variety of knobs that the knob timer may adapt to.

### DETAILED DESCRIPTION

In this disclosure the term the “original” timer shall come to mean the device that ultimately drives the direction of the controlled knob, or adjusts the energy provided to an electrical appliance. The term may be used interchangeably with the term “knob timer”, however in the case when a plurality of “knob timers” are operating in coordination with one another, the “original” timer would be the knob timer that leads the motion of the other knob timers. A knob timer may be affixed to an appliance by means including but not limited to said knob timer having a magnetic backing, adhesive backing, a Velcro backing meeting an interlocking Velcro affixed to said appliance such that it protrudes in the direction of the knob timer backing, an interlocking gear backing, a backing with pins to grab around an existing knob or some combination therein.

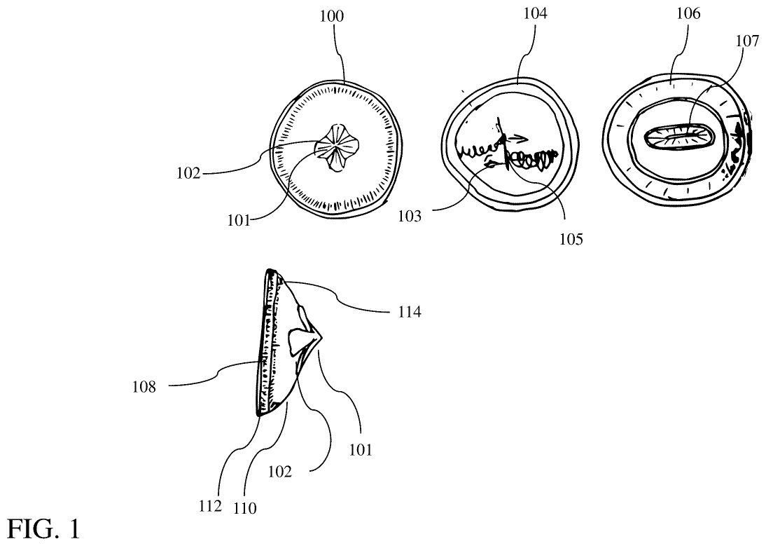

FIG. 1 is an image of a knob timer 100 in various orientations, wherein a mechanical knob 102, with various contours 100, which may be placed over a preexisting analog stove or oven setting knob or stub and may be driven by hand to set the timer, or in some embodiments it may be instead driven or set by a signal. In one view the underside of the knob timer is shown where a contour 104 which may have suction in some such embodiments, may be mounted around a stove knob or in place of one as one or more springs 105, are used in conjunction with one or more latches 103 to drive the stove knob to close or a preset lower temperature when the timer completes or reaches a which may be fitted over various sizes of knobs, wherein one or more spring loaded mechanisms may drive said knob to one or more positions, once the knob timer reaches one or more positions, triggering a release of one or more springs.

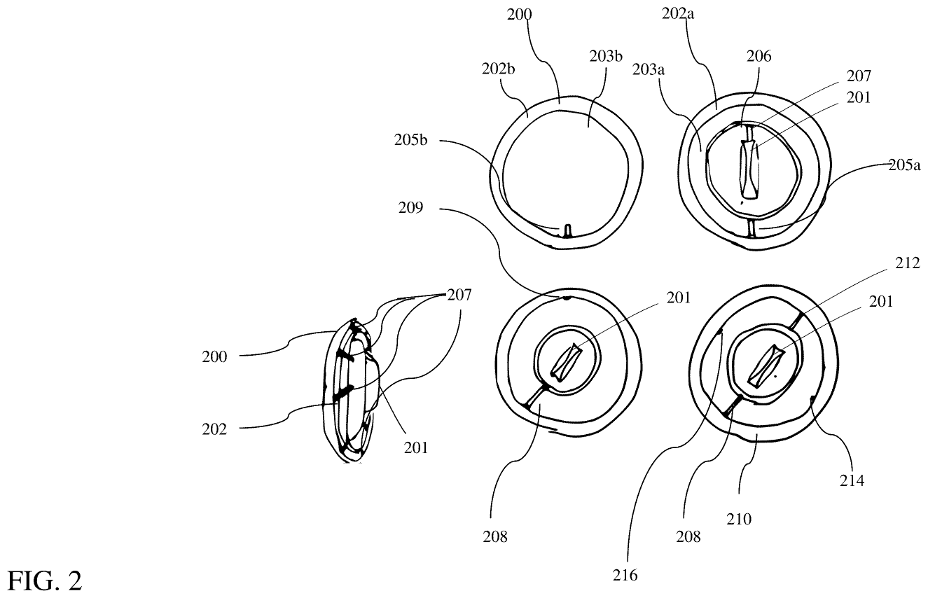

FIG. 2 is an image of a knob timer 200 which may be fitted over various sizes of knobs, where the underside 202b of the outer ring 202a may have a mechanism for attaching to the face of the stove, including but not limited to adhesive, magnets, or suction, the underside 203b of the inner ring 203a having space for a variety of existing stove knobs, stove knob stubs, oven knobs, or oven knob stubs in some such embodiments. The timer mechanism 201 may be hand spun to set in some such embodiments or electronically set in other embodiments. One or more inner latches 207 and/or outer latches 205 may be set 205a around the surface of the knob timer in some such embodiments or depressed 205b to release the knob timer 201 or one or more mechanisms including but not limited to gears, springs or some combination therein that will drive the knob controlling the heat to one or more positions, including but not limited to a lower heat position or the off position. In some such embodiments an inner latch 208 and/or outer latch 212 which in some such embodiments may be left and right prongs may be rotated and fitted over said knob and reset to their original position relative to the outer knob timer 210 which remains stationary as the latches and inner knobs are propelled by a motor once the timer one or more setpoints.

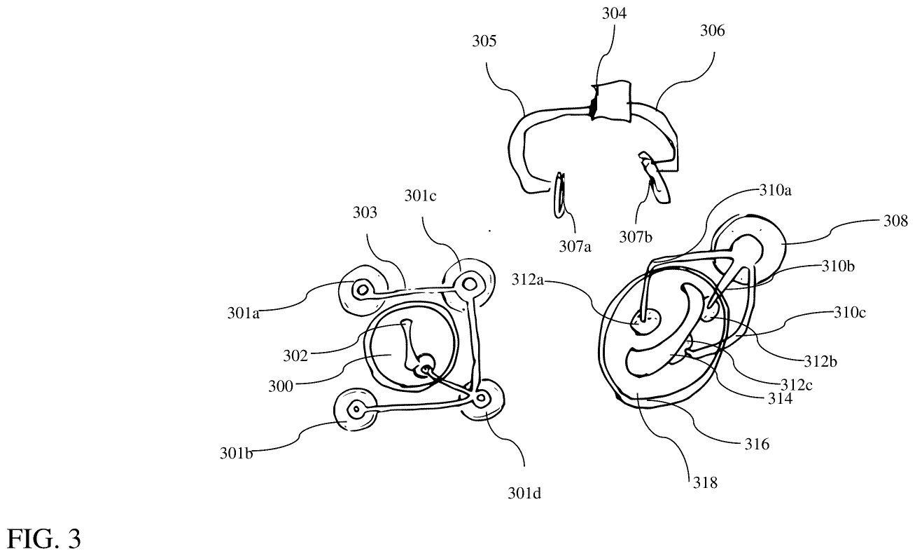

FIG. 3 is an image of a knob timer which 300 may be adjoined to and drive an inner knob by mechanism 302 including but not limited to arms 303 with suction cups on the end, which rotate in the direction driven by one or more knob timers 301a-301d. In some such embodiments an external timer 304, may drive one or more arms 305, 305 which attach to one or more stove knobs utilizing an attachment 307a, 307b including but not limited to suction cups, magnets, or adhesive. In other such embodiments one external timer 308 may be used to drive a knob 316, to close. In some such embodiments the external timer may have a shell 316 that is placed over top of an existing knob, with one or more arms 310a-310c attached 312a-312c to said shell 316, which in some such embodiments may have an external knob dial 316 to set the temperature.

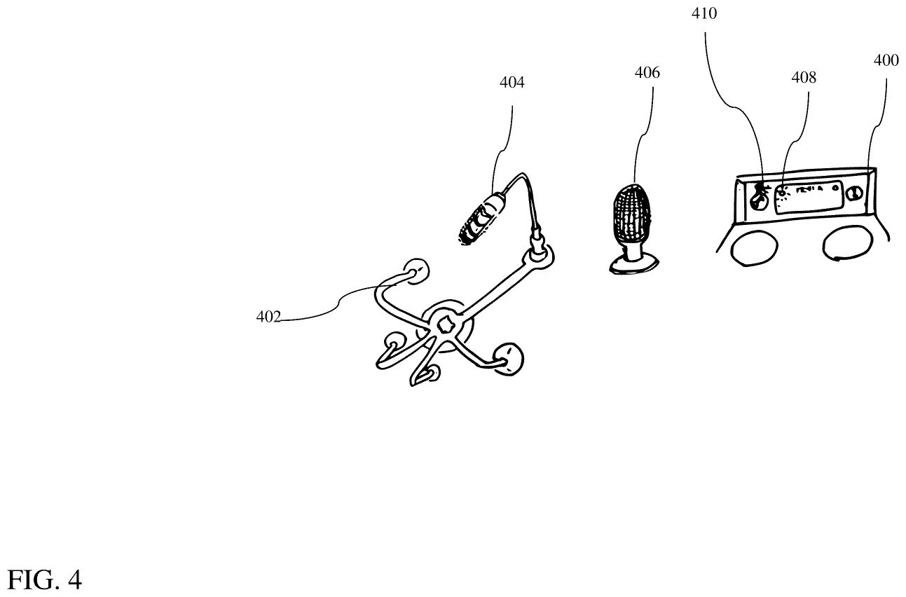

FIG. 4 is an image of a knob timer device 402 with an environmental sensor 404, including but not limited to auditory (in some embodiments specifically a microphone, visual (in some embodiments, specifically a photosensor that detects a pattern of light blinks from a device designed to interoperate), temperature, or due to sensed gases, including but not limited to LEL, smoke, or carbon monoxide, causing the knob timer to drive a stove 400 knob 410 to one or more positions, and in some such embodiments, alarm 408, sending a signal to one or more users electronically.

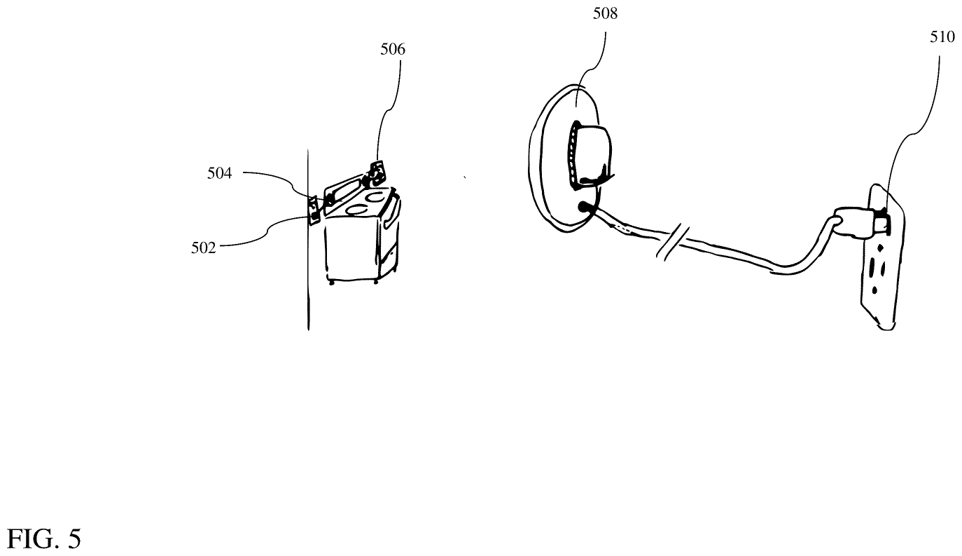

FIG. 5 is an image of a knob timer 508 with an AC adapter 510, for recharging or extended DC preservation in some such embodiments. In some such embodiments a plugged in stove timer device 502 may be digitally linked to an electric stove/oven to send a signal to turn it off after a certain time has passed, physically linked to an electric stove/oven 504 and shut it off or modulate the power to adjust when the timer reaches a certain set point, including but not limited to 0. In some other such embodiments a sensor 506 may be used to transmit a signal to the plugged-in sensor 504, to shut the stove/oven off when a criterion is reached, including but not limited to temperature, smoke/vapor particles being sensed, or a certain sound such as popping being detected.

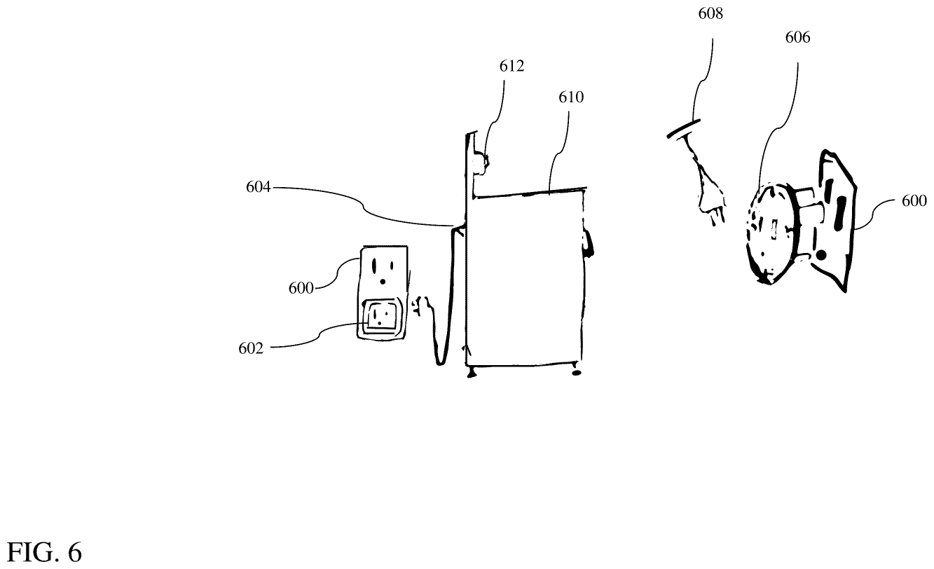

FIG. 6 is an image of a knob sensor 612 which is interoperating with an additional sensor 602, which may be plugged in to an AC socket 600, said additional sensor designed in some embodiments to detect the presence of smoke, gases or other sensed items that the original knob sensor may not be able to detect, and sending a signal that the original knob sensor 612 can detect, thereby driving the original knob to one or more positions. In some such embodiments a stove/oven may be plugged into the additional sensor 602, and be shut off directly by it as an additional safety factor. In some other embodiments the sensor 606 may be fitted to an external plug 608 or send a signal to the stove/oven knob sensor 612 and/or a local sensor 602, to provide redundancy and additional safety measures.

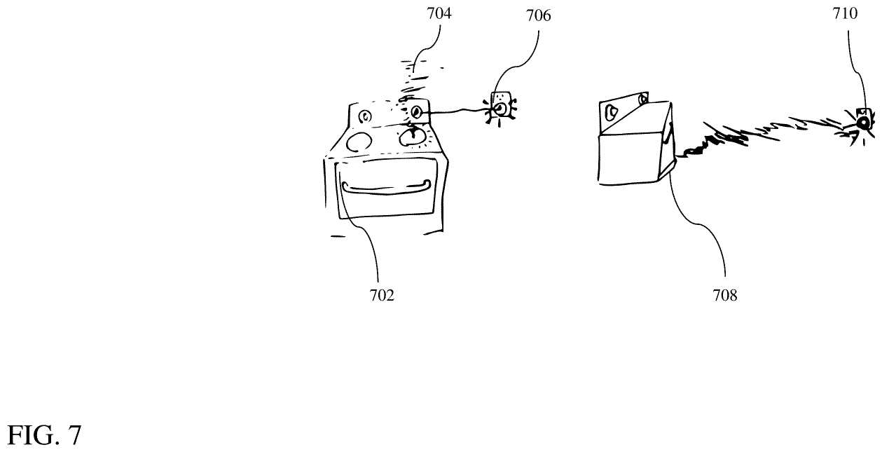

FIG. 7 is an image of a knob timer 704 which may detect smoke 704 and in addition to turning off a stove 702, and send a signal to a remote alarm 706 to alarm accordingly. In some other such embodiments smoke from an oven 708 may be sensed by a remote plug sensor 710 and subsequently send a signal to the unit and/or user to shut off the oven remotely.

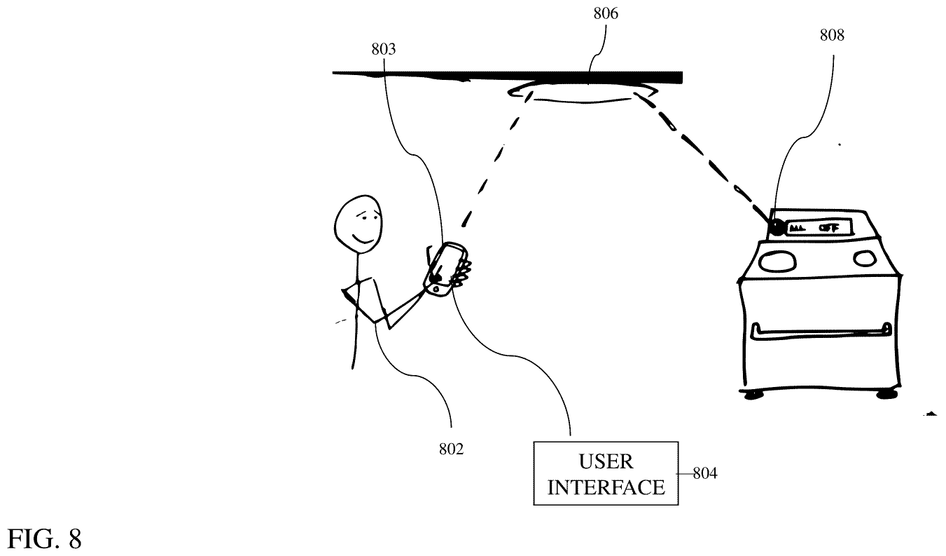

FIG. 8 is an image of a user 802 holding a cell phone 803 and sending a signal to a knob timer 808, using a graphical user interface 804, so the knob timer changes its position or program it to adjust its parameters accordingly. In some such embodiments these signals may be relayed through a relay point 806 which can include but is not limited to a database, relay transmitter or other digital relay mechanism.

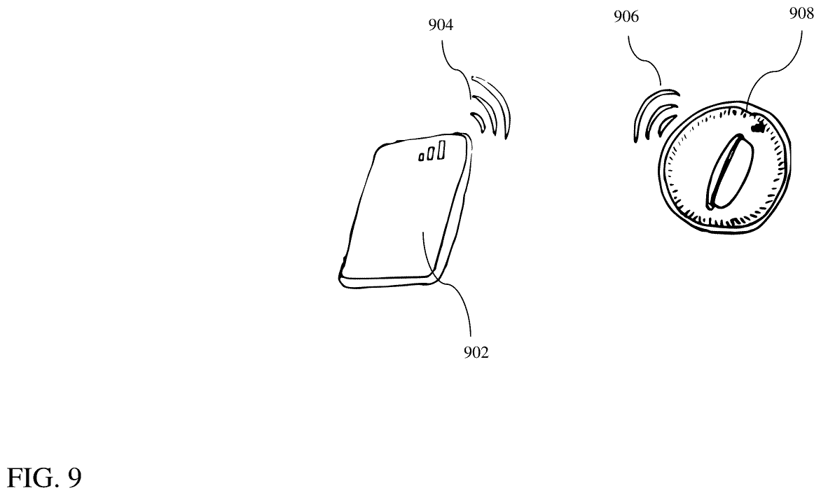

FIG. 9 is an image of a device 902 (in this case a wifi 904 enabled cell phone) sending a signal to a knob timer 908 (in which in this case also is wifi 906 enabled), where the knob timer receives, adjusts in response to or communicates back with information regarding its position or maintenance to, or some combination therein.

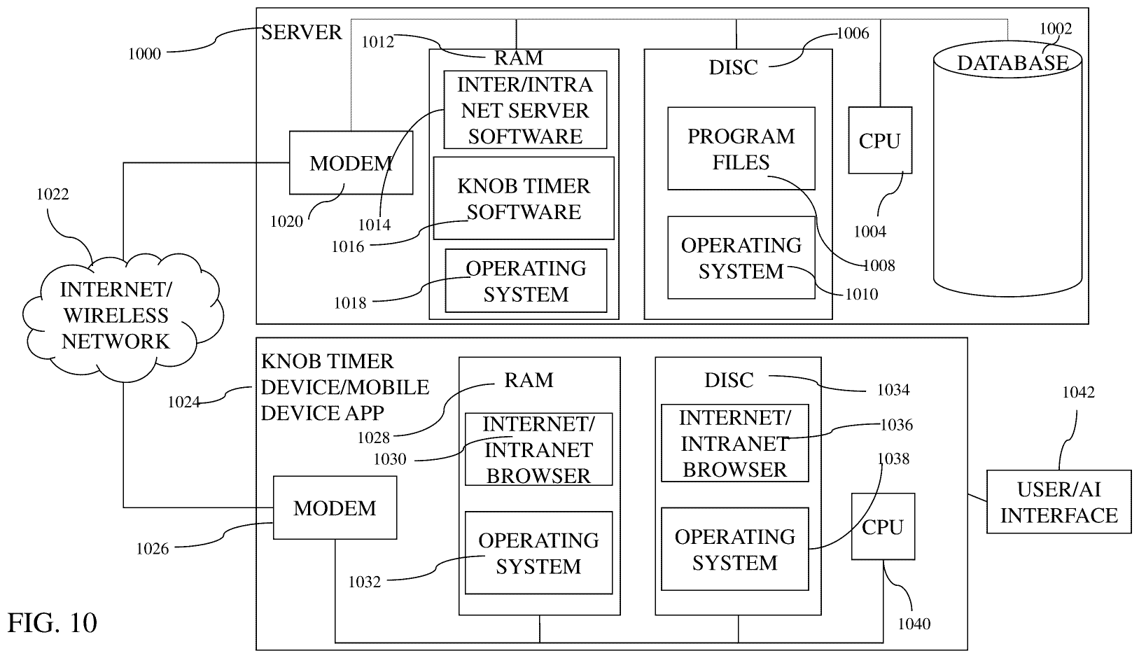

FIG. 10 is an exemplary embodiment following a standard Internet architecture in which one or more Knob Timer Device/Mobile Device App 1024 and a server 1000 are connected via the internet/wireless network 1022 and modems 1026, 1020 or other communications channels. A user accesses the server 1000 via a User Interface or AI interface 1042 relaying information about the user or via direct verbal commands and operating a web browser 1030 or other software application residing in RAM memory 1028 that allows it to display information downloaded from a server 1000. The server system 1000 runs server software 1014, including the knob timer software 1016 of the present invention, which interacts with the knob timer device 1024 and a user information database 1002. The database 1002 contains data regarding individual device performance collected via sensors, data regarding a group of devices performance (such as in a commercial kitchen) measured by sensors, data regarding the area collected sensors plugged in the area, data from the users collected by user input, prerecorded data or some combination therein. The knob timer software 1016 in some situations will process a user's verbal commands by acting in means including but not limited to pulling information from the database 1002 adding information to it, sending information back to the device such it can respond verbally to the user in language they will understand. Both the server 1000 and the knob timer device/mobile app device 1024 include respective storage devices, such as hard disks 1006 and 1034 and operate under the control of operating systems 1018, 1032 executed in RAM 1012, 1028 by the CPUs 1004, 1040. The server storage device 1006 stores program files 1008 and the operating system 1038. Similarly, the user storage devices 1034 store the inter/intranet browser software 1036 and the operating systems 1038. Typically, the user would utilize the user interface 1042 on their mobile device application 1024 but in some such embodiments it may be on the knob timer device itself 1024. In some such exemplary embodiments this system may involve an application which may process a variety of functions including but not limited to driving a system of knob sensors or sensors that interoperate with the knob timer and send one or more signals to the knob timer in order to drive it to one or more positions, and may comprise additional functions including but not limited sensing when one or signals are received including but not limited to audio, visual, tactile, temperate, digital from another device or a user input and sends a signal to the knob timer or records data regarding the timer, including but not limited to its position, battery life, temperature, or another signal sent from the knob timer and stored in the database.

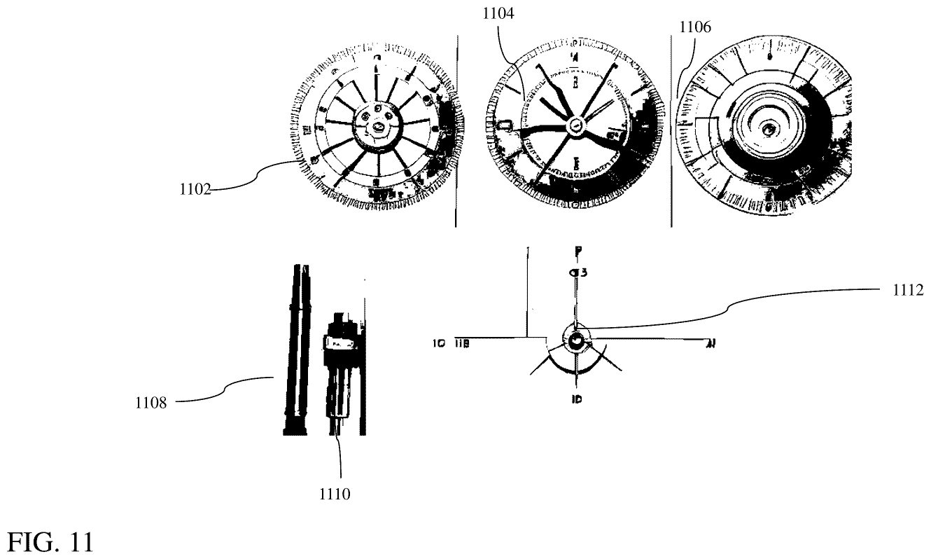

FIG. 11 is a drawing illustrating a variety of knob timers, including but not limited to a hand operated timer 1102 that drives a stove to the off position immediately once the timer reaches 0, a mechanical latch driver based timer 1104 with multiple set points for driving a stove to one or more heat settings at one or more times, and a digital timer 1106 that is driven by a remote application or detection of sensed environmental factors, including but not limited to smoke, temperature, sound or vibration. These knob timers may be may be placed over a knob, or an exemplary embodiment of a stove temperature knob stub 1112, with the knob timers coming with adjustable knob depressing covers 1108 or 1110 for use in gas as opposed to electrical stoves, where a knob must be pressed-in in order to change the setting.

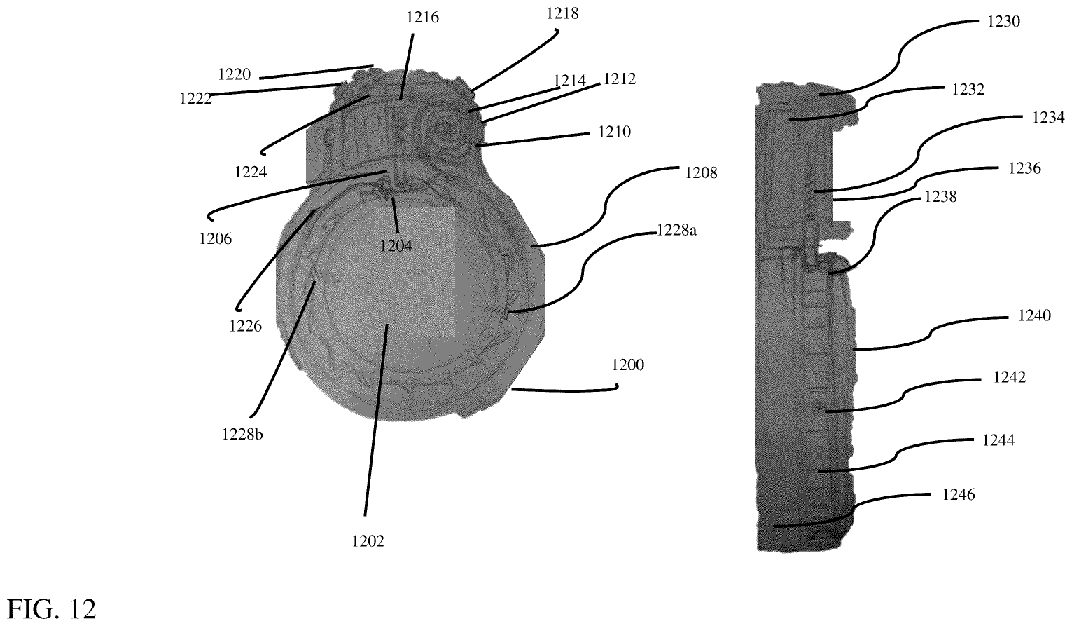

FIG. 12 is a drawing of a pivot mounted knob 1202 which may be placed over an existing knob or stub, and control some such knobs with the use of one or more set screw 1228a, 1228b. In some such embodiments said pivot mounted knob may be driven by a spring coil 1226 made of compressible material including but not limited to aluminum, steel, or a rubber composite. Said spring may be released by a spring pin 1206, driven by an actuator 1216, which may be controlled by a CPU “brain” 1214. Timer controls 1220, 1222 and reset buttons 1218 may be used to adjust the brain locally, with a timer display 1210 being used to drive a launching spring coil 1212 in some such embodiments. In some other embodiments a relay 1224 “brain” may transmit a signal “1214” to control the mechanism remotely. Some such pivot mounted knobs may have a stationary base 1200. A side profile reveals that some such embodiments of the pivot mounted knob include a sidewall cover 1246, where a dial 1244 may be adjusted as set screws are driven inward 1242, said cover having additional space 1240 for a push-in on gas stoves as a drive in mechanism or gear 1238 exists to press the knob in when the timer zeros, as driven by springs 1234, from a casing 1230 above, with a cpu 1232 sending information to a user's device or displaying information related to the sensor on a local display 1236.

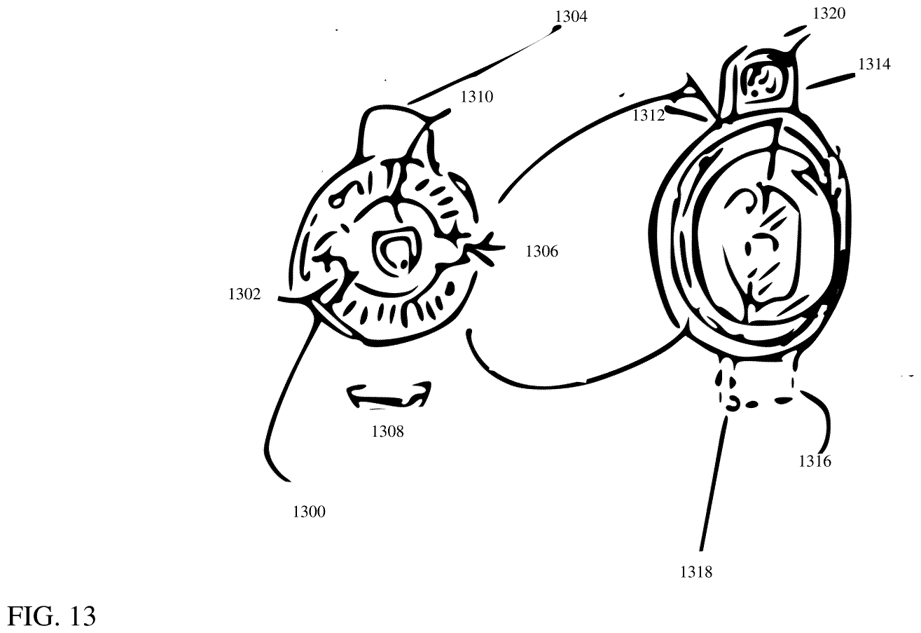

FIG. 13 is a drawing representing a pivoting spring-loaded flywheel-based knob timer 1300 comprising a flywheel 1310, spring 1302, one or more triggers 1306 and the ability to reorient the face 360 degrees 1308, as the unit clips to the stove, a knob or both. A top mounted accessory 1304 can be used for various functions in some such embodiments including but not limited to locking the unit in place, displaying information related to time, temperature or serving as a relay or alarm. In some other embodiments the pivoting spring-loaded flywheel-based knob timer may have an adherent 1312 to adhere to the stove as a gyroscope 1314 is installed in addition to a position monitor 1314 to detect the heat setting one or more stoves are driven to, with room for additional mechanisms to be installed as needed 1316 in order to adjust for various brands of stoves or incorporate additional functionality as inner ring springs, relative to the outer ring 1318.

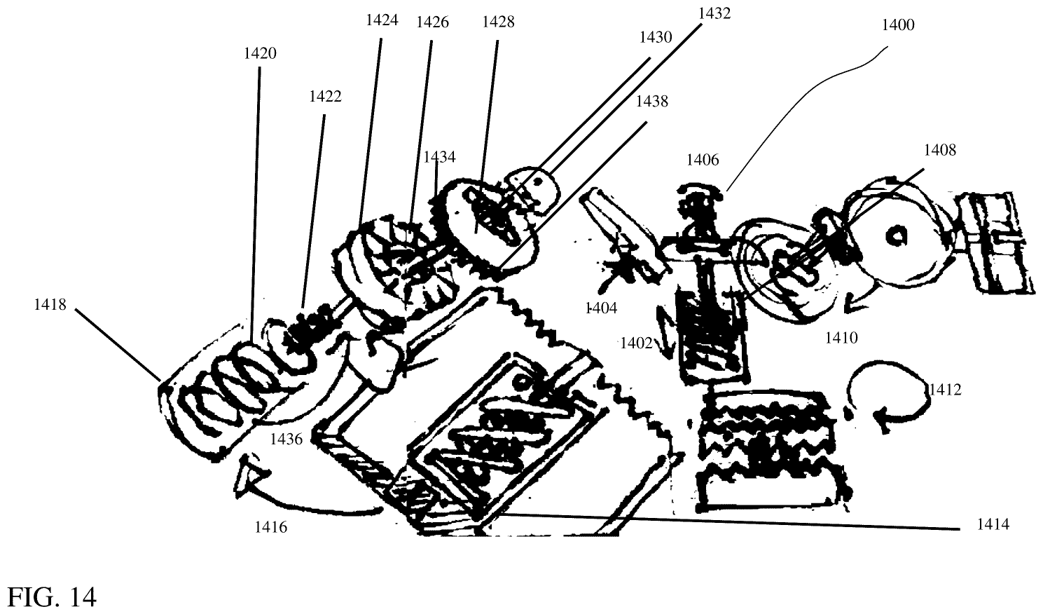

FIG. 14 is an image showing a knob timer device 1400, which is extruded to show it's inner components in an exemplary embodiment including a spring 1408, which may be compressed and rotate a flywheel 1404 in torsion, which may twist 1410 and rotate the position of an oven knob 1412, when a latch mechanism 1438 depresses after the oven timer knob 1432 finishes spinning past a certain point 1430 on the outer face 1428 of the knob timer device. This causes the spring 1422 to rotate 1436 within the spring housing 1418 following a series of events that may include the gears or teeth of the outer ring 1434 driving the grooves below 1426 as part of an inner flywheel 1424 to close as a larger outer spring 1420 rotates 1416 in some such embodiments, thereby turning a stove or oven knob to an off position or another set position as guided by one or more latches in some such embodiments.

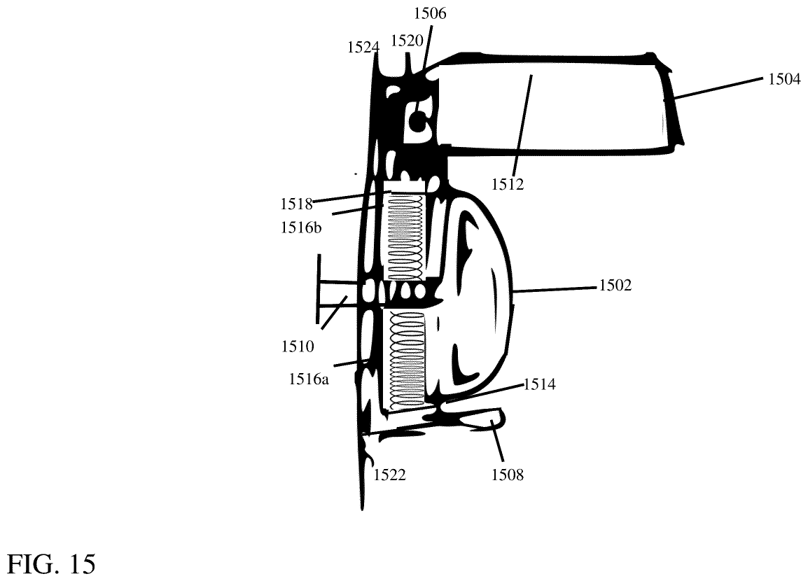

FIG. 15 is figure showing a knob timer device 1502 with a safety cover 1504, which may pivot to close at a pivot point 1506, so the safety cover 1504 may close and latch in place resting along a sidewall 1514 and against a bottom latch 1508 in some such embodiments, as space 1512 within the cover ensures the knob is not affected as the cover shields the knob timer from splashes or other contaminants. A “brain” 1520 or actuator 1524 may drive a trigger 1518 which causes one or more springs 1516a, 1516b to compress or depress such that a knob timer may push-in 1510 toward a stove 1522 so that the stove is adjusted or turned off when the timer completes.

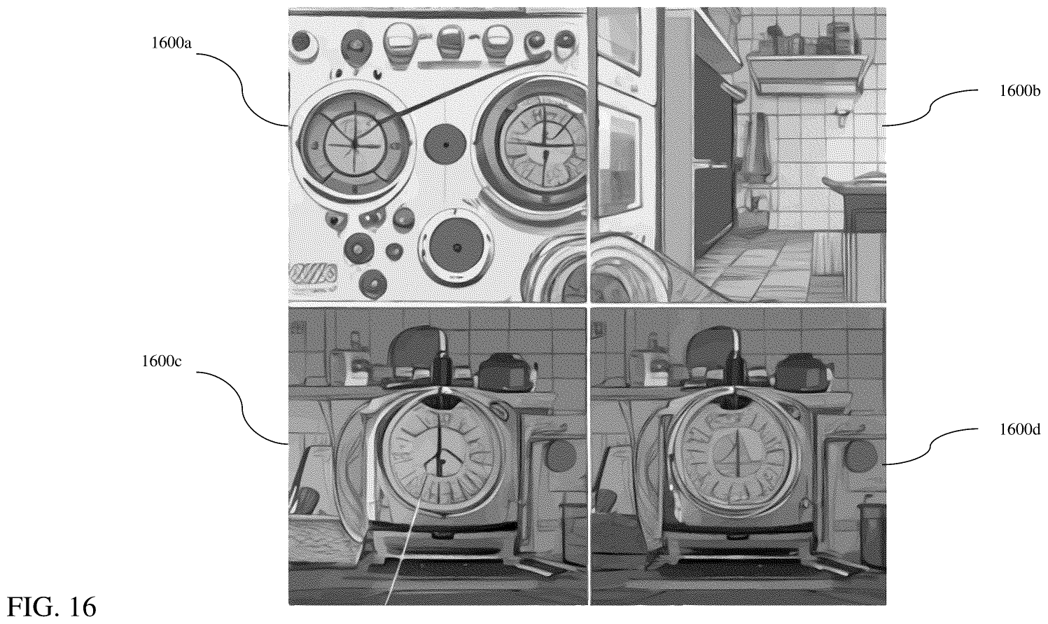

FIG. 16 is an overview drawing illustrating various views of a kitchen. A stove knob timer set with various parts and adapters that may be placed over a stove is shown 1600a, with an exemplary kitchen being displayed 1600b where a hand driven knob timer knob is shown set over a stove knob stub in one embodiment 1600c and a larger knob timer is shown placed over an existing stove knob without the need to remove the knob and place the stove knob timer over the stub in another embodiment 1600d may be used to shut off a stove or oven for convenience and fire safety.

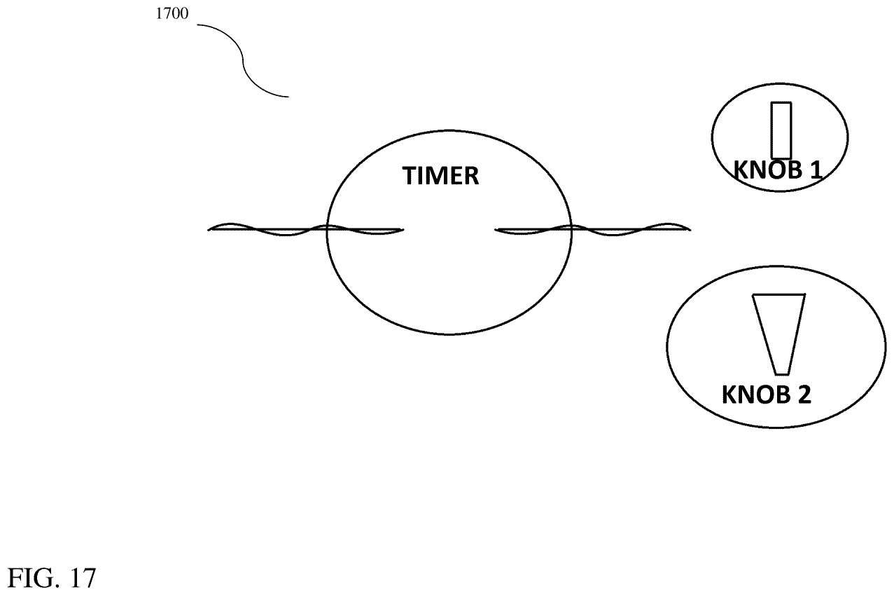

FIG. 17 is an overview drawing illustrating a variety of knobs that the knob timer may where a knob timer with set screws can be placed over such knobs, the set screws adjusting to and adapting to one or more knob sizes as adjusted.

It is understood that the various preferred embodiments are shown and described above to illustrate different possible features of the invention and the varying ways in which these features may be combined. Apart from combining the different features of the above embodiments in varying ways, other modifications are also considered to be within the scope of the invention.

The invention is not intended to be limited to the preferred embodiments described above, but rather is intended to be limited only by the claims set out below. Thus, the invention encompasses all alternate embodiments that fall literally or equivalently within the scope of these claims.

Having thus described my invention, I claim:

1. A device comprising a knob,
a timer;
one or more release mechanisms;
and a mechanism for controlling the position of an inner knob or knob stub
wherein said timer may be set to a pre-defined or user defined time and
wherein said knob may be set to a pre-defined or user defined position and one or more release mechanisms is triggered when the timer reaches one or more particular positions, causing said knob to rotate in a clockwise or counterclockwise direction, said knob being designed to place it over an existing knob or knob stub and drive it to a particular position when the timer reaches one or more positions.

2. The device in claim 1 further wherein the mechanism for controlling the position of the inner knob is one or more set screws; the one or more release mechanisms is one or more compressed springs, and the device is designed to simultaneously exert pressure in the perpendicular direction to the set screws on the inner knob or knob stub so that it can turn an existing stove knob or stove knob stub where a press-in is required to turn.

3. The device described in claim 1 wherein said release mechanism is a compressed spring that is loaded when the timer is turned and depresses only when the timer reaches zero, and the device drives the inner knob or knob stub to the off position.

4. The device described in claim 1 wherein the device has an outer casing that is mounted to a fixed position via an adhesive, clamp, or magnet.

5. The device described in claim 3 further comprising a user operated dial attached to a guide which depresses the release mechanism until the timer reaches the position the user sets on the dial, thereby activating a motor which drives the inner knob.

6. The device described in claim 1 further comprising a safety cover.

7. The device described in claim 4 further comprising one or more pins which may be pressed in to release the inner knob to a particular position once the timer reaches the position of the pin.

8. The device described in claim 4 further comprising a plurality of user operated dials attached to a respective plurality of block which bar the released spring from driving the clamps in a direction beyond the user defined angle, and further comprising a plurality of user operated dials, attached to a respective plurality of guides which further depress the release mechanism thereby releasing the aforementioned block until the timer reaches the position the user sets on the respective dial, thereby rereleasing the spring which drives the inner knob.

9. The device described in claim 5 further comprising an environmental sensor which triggers the release of a mechanism driving the inner knob when a predefined environmental hazard is detected.

10. The device in claim 9 further comprising an acoustic sensor, that when a particular pattern is sensed begins to activate the timer on said knob.

11. The device in claim 1, wherein a hole exists for an existing knob to sit, and further comprising one or more pins that may retract or protrude and fit inside a hole in the inner knob, around the inner knob, or adjacent the inner knob, such that when the device resets, it causes the inner knob to reset.

12. A system comprising a timer;
a release mechanism;
and a mechanism for driving a contained knob in torsion, compression, counterclockwise, clockwise, or laterally (such as pressing in or pulling outward from the face of a device it's resting on.

13. The system in claim 14 further comprising a plug for powering the device, charging the device or a combination therein.

14. A system as in claim 14 wherein the timer is purely mechanical, operated by a series of gears and motors, that when rotated, immediately begin driving the knob to one or more positions that activate an inner device to drive a knob or the stem of a knob, to one or more positions such that one or more range may be reached.

15. The system as in claim 14 wherein the driven knob is a kitchen knob, such that the height of the flame may be adjusted to any preset or user set point.

16. A system as in claim 14 wherein one or more additional devices have interoperability with and add functionality to the original “timer”, in some such embodiments sensing one or more additional environmental changes including but not limited to a change in temperature, smoke detection, carbon monoxide detection, LEL gas detection or an auditory signal that causes the device to communicate with the original “timer” and drive it to a close.

17. A system as in claim 18 where the original “timer” is plugged into the same outlet as an electric stove or oven and modulates the energy to the device when an environmental change is detected, the timer reaches one or more preset or user set points, or the device receives a signal from another device to adjust its position.

18. A system as in claim 14 wherein a timer is driven to one or more positions by one or more users, attendants, algorithms or artificial intelligence entities, sending a signal to said device, or another device that the device can interoperate the signal and translate it to said device, in some embodiments, said signal being sent via a communications network including but not limited to Bluetooth, wifi, near field communication or the internet, and in some such embodiments, the position of the driven device may be stored in a database that is communicated to one or more devices, in some such embodiments, said communicated to device being the original “timer” itself.

19. A method of a device of claim 1 driving a stove to the off position when the timer reaches zero.

20. A method of controlling one or more electric stoves or ovens using one or more timers which plug into one or more wall sockets and receive signals from one or more plug in sensors which detect environmental hazards including smoke, and turns off or adjusts the power to the one or more plugged in electric stoves or ovens when a hazard is detected or the timer reaches zero respectively.
